(19) United States
(12) Patent Application Publication
(10) Pub. No.: US 2010/0020046 A1
(43) Pub. Date: Jan. 28, 2010

(54) METHOD OF DRIVING INFORMATION DISPLAY PANEL

(75) Inventors: Norio Nihei, Kodaira-shi (JP); Akihiko Yokoo, Kodaira-shi (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, Chuo-ku, Tokyo (JP)

(21) Appl. No.: 12/442,032

(22) PCT Filed: Sep. 20, 2007
(86) PCT No.: PCT/JP2007/068292

§ 371 Date: Apr. 2, 2009

(30) Foreign Application Priority Data
Sep. 20, 2006 (JP) 2006-254785

(51) Int. Cl. G09G 5/00

(52) U.S. Cl. 345/204

(57) ABSTRACT

A method of driving an information display panel: in which at least one group of display media constituted by at least one group of particles, at least one substrate being transparent; in which the display media, to which an electrostatic field generated between the substrates is applied, are made to move so as to display information such as an image; and in which an electrostatic field is applied more than once for moving the display media in respective pixels; is disclosed. In the method of driving an information display panel, during a time interval at which an electrostatic field is not applied in the course of said multiple electrostatic field application, an electrostatic field application for the other multiple electrostatic field application is performed.

### TECHNICAL FIELD

The present invention relates to a method of driving an information display panel, in which at least one group of display media constituted by at least one group of particles, at least one substrate being transparent, and, in which the display media, to which an electrostatic field generated between the substrates is applied, are made to move so as to display information such as an image.

### RELATED ART

Generally, it is known various methods of driving an information display panel, in which at least one group of display media constituted by at least one group of particles, at least one substrate being transparent, and, in which the display media, to which an electrostatic field generated between the substrates is applied, are made to move so as to display information such as an image. Among them, it is known a method of driving an information display panel, wherein, in a passive matrix drive, in which a voltage is applied to a plurality of row electrodes extending in a row direction on one substrate and a plurality of column electrodes extending in a column direction on the other substrate by scanning the row electrode from one end to the other end, in order to reduce a crosstalk generated at an image display, a plurality of pulse voltages each constructed by a drive voltage having ON state and a voltage having OFF state below a threshold value at which the display media starts to move are applied to the row electrode to be displayed so as to display information such as an image (for example, Japanese Patent Laid-Open Publication No. 2005-331903).

FIG. 10 is a schematic view explaining one embodiment of the known method of driving an information display panel mentioned above. In the embodiment shown in FIG. 10, four pulse voltages each constructed by ON state and OFF state are applied to respective row electrodes, so that a writing pulse for respective row electrodes is realized. Here, if it is assumed that a time interval during which the writing pulse is applied to one row electrode is t1, a time interval of t1×n is required when the number of row electrodes is n. Therefore, there is a drawback such that a time interval for displaying one screen is long.

### DISCLOSURE OF THE INVENTION

The present invention has for its object to eliminate the drawbacks mentioned above and to provide a method of driving an information display panel, which can reduce a time interval required for displaying one screen, when information such as an image is to be displayed.

According to the present invention, a method of driving an information display panel: in which at least one group of display media constituted by at least one group of particles, at least one substrate being transparent; in which the display media, to which an electrostatic field generated between the substrates is applied, are made to move so as to display information such as an image; and in which an electrostatic field is applied more than once for moving the display media in respective pixels; is characterized in that, during a time interval at which an electrostatic field is not applied in the course of said multiple electrostatic field application, an electrostatic field application for the other multiple electrostatic field application is performed.

Moreover, as a preferable embodiment of the method of driving an information display panel, in a passive matrix drive, in which a voltage is applied to a plurality of row electrodes extending in a row direction on one substrate and a plurality of column electrodes extending in a column direction on the other substrate by scanning the row electrode from one end to the other end, when a plurality of pulse voltages each constructed by a drive voltage having ON state and a voltage having OFF state below a threshold value at which the display media starts to move, said other multiple electrostatic field application is performed by successively applying a pulse voltage having ON state to a plurality of row electrodes other than a row electrode which is a display standard, during which said row electrode which is the display standard is in OFF state.

According to the invention, in the method of driving an information display panel, in which an electrostatic field is applied more than once for moving the display media in respective pixels, since, during a time interval at which an electrostatic field is not applied in the course of said multiple electrostatic field application, an electrostatic field application for the other multiple electrostatic field application is performed, it is possible to obtain a method of driving an information display panel, which can reduce a time interval required for displaying one screen, when information such as an image is to be displayed.

### BRIEF DESCRIPTION OF THE DRAWINGS

FIGS. 1a and 1b are schematic views respectively showing one embodiment of an information display panel which is an object of a driving method according to the invention.

FIGS. 2a and 2b are schematic views respectively illustrating another embodiment of an information display panel which is an object of a driving method according to the invention.

FIGS. 3a and 3b are schematic views respectively depicting still another embodiment of an information display panel which is an object of a driving method according to the invention.

FIGS. 4a and 4b are schematic views respectively showing still another embodiment of an information display panel which is an object of a driving method according to the invention and a construction of outer electrodes used as an outer electrostatic field applying means which is combined with the information display panel mentioned above.

FIGS. 5a and 5b are schematic views respectively illustrating still another embodiment of an information display panel which is an object of a driving method according to the invention.

FIG. 6 is a schematic view depicting still another embodiment of an information display panel which is an object of a driving method according to the invention.

FIG. 7 is a schematic view showing still another embodiment of an information display panel which is an object of a driving method according to the invention.

FIG. 8 is a schematic view explaining one embodiment of a method of driving an information display panel according to the invention.

FIG. 9 is a schematic view illustrating one embodiment of partition wall shapes of the information display panel which is an object of a driving method according to the invention.

FIG. 10 is a schematic view explaining one embodiment of the known method of driving an information display panel.

### BEST MODE FOR CARRYING OUT THE INVENTION

At first, a basic construction of an information display panel which is an object of the invention will be explained. In the information display panel which is an object of the present invention, an electrostatic field is applied to the particles sealed between opposed two substrates. Charged particles are attracted along a direction of electrostatic field to be applied by means of Coulomb's force in such a manner that the particles charged at a low potential are attracted toward a high potential side and the particles charged at a high potential are attracted toward a low potential side, and thus the particles can be moved reciprocally by varying a direction of electrostatic field due to a switching operation of potential. Accordingly, an image can be displayed. Therefore, it is necessary to design the information display panel in such a manner that the display media can move evenly and maintain stability during a reciprocal operation or during a reserving state. Here, in the case of using particles or liquid powders as the display media, as to forces applied to the particles, there are an attraction force between the particles due to Coulomb' force, an imaging force with respect to the electrode panel, an intermolecular force, a liquid bonding force and a gravity.

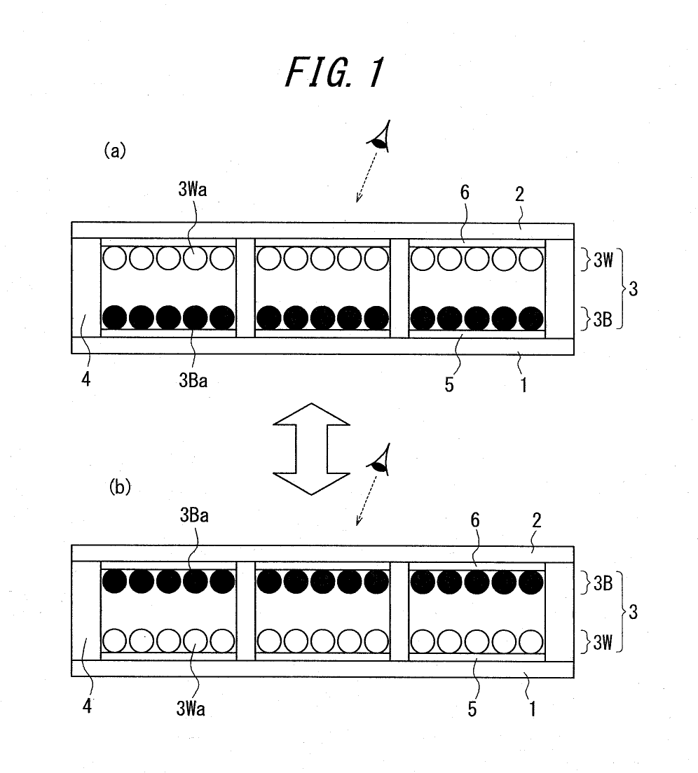

Examples of the information display panel which is an object of the invention will be explained with reference to FIGS. 1a and 1b-FIG. 7.

In the examples shown in FIGS. 1a and 1b, at least two or more groups of display media 3 having different optical reflectance and charge characteristic and consisting of at least one or more groups of particles (here, white color display media 3W made of the particles constituted by particles 3Wa for white color display media and black color display media 3B made of the particles constituted by particles 3Ba for black color display media are shown) are moved in a perpendicular direction with respect to substrates 1 and 2, in accordance with an electric field generated by applying a voltage between an electrode 5 (individual electrode) arranged to the substrate 1 and an electrode 6 (individual electrode) arranged to the substrate 2. Then, as shown in FIG. 1a, a white color display is performed by viewing the white color display media 3W to the observer, or, as shown in FIG. 1b, a black color display is performed by viewing the black color display media 3B to an observer. Moreover, in FIGS. 1a and 1b, the partition walls arranged at the near side are omitted.

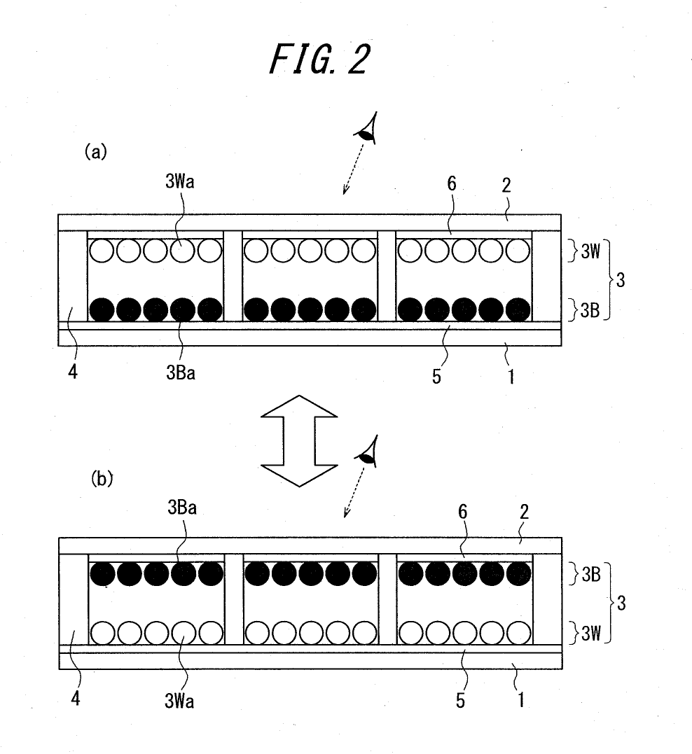

In the examples shown in FIGS. 2a and 2b, at least two or more groups of display media 3 having different optical reflectance and charge characteristic and consisting of at least one or more groups of particles (here, white color display media 3W made of the particles constituted by particles 3Wa for white color display media and black color display media 3B made of the particles constituted by particles 3Ba for black color display media are shown) are moved in a perpendicular direction with respect to substrates 1 and 2, in accordance with an electric field generated by applying a voltage between an electrode 5 (line electrode) arranged to the substrate 1 and an electrode 6 (line electrode) arranged to the substrate 2. Then, as shown in FIG. 2a, a white color display is performed by viewing the white color display media 3W to the observer, or, as shown in FIG. 2b, a black color display is performed by viewing the black color display media 3B to an observer. Moreover, in FIGS. 2a and 2b, the partition walls arranged at the near side are omitted.

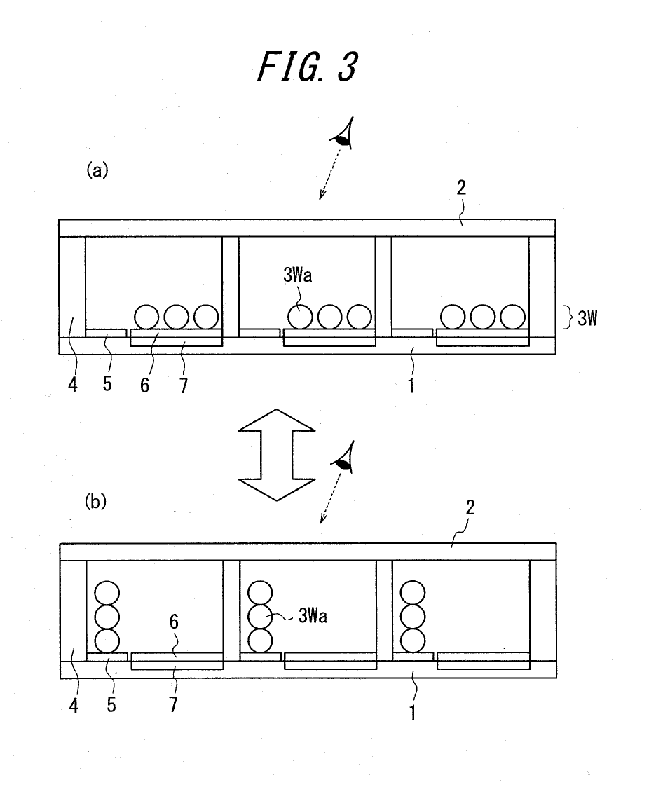

In the examples shown in FIGS. 3a and 3b, at least one group of display media 3 having different optical reflectance and charge characteristic and consisting of at least one or more groups of particles (here, white color display media 3W made of the particles constituted by particles 3Wa for white color display media) are moved in a parallel direction with respect to substrates 1 and 2, in accordance with an electric field generated by applying a voltage between the electrode 5 and the electrode 6 arranged to the substrate 1. Then, as shown in FIG. 3a, a white color display is performed by viewing the white color display media 3W to the observer, or, as shown in FIG. 3b, a black color display is performed by viewing the black color display media 3B to an observer. Moreover, in FIGS. 3a and 3b, the partition walls arranged at the near side are omitted.

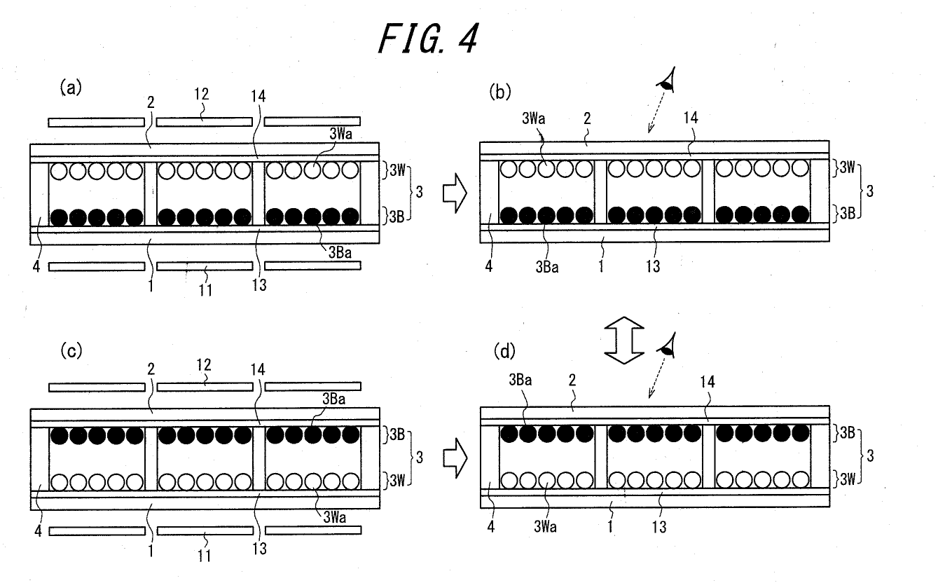

In the examples shown in FIGS. 4a-4d, firstly as shown in FIGS. 4a and 4c, at least two or more groups of display media 3 having different optical reflectance and charge characteristic and consisting of at least one or more groups of particles (here, white color display media 3W made of the particles constituted by particles 3Wa for white color display media and black color display media 3B made of the particles constituted by particles 3Ba for black color display media are shown) are moved in respective cells formed by the partition walls 4 in a perpendicular direction with respect to substrates 1 and 2, in accordance with an electric field generated by applying a voltage between an outside electric field generating means 11 arranged outside of the substrate 1 and an outside electric field generating means 12 arranged outside of the substrate 2. Then, as shown in FIG. 4b, a white color display is performed by viewing the white color display media 3W to the observer, or, as shown in FIG. 4d, a black color display is performed by viewing to the observer, or, as shown in FIG. 4d, a black color display is performed by viewing the black color display media 3B to an observer. Moreover, in FIGS. 4a-4b, the partition walls arranged at the near side are omitted. Further, a conductive member 13 is arranged inside of the substrate 1, and a conductive member 14 is arranged inside of the substrate 2.

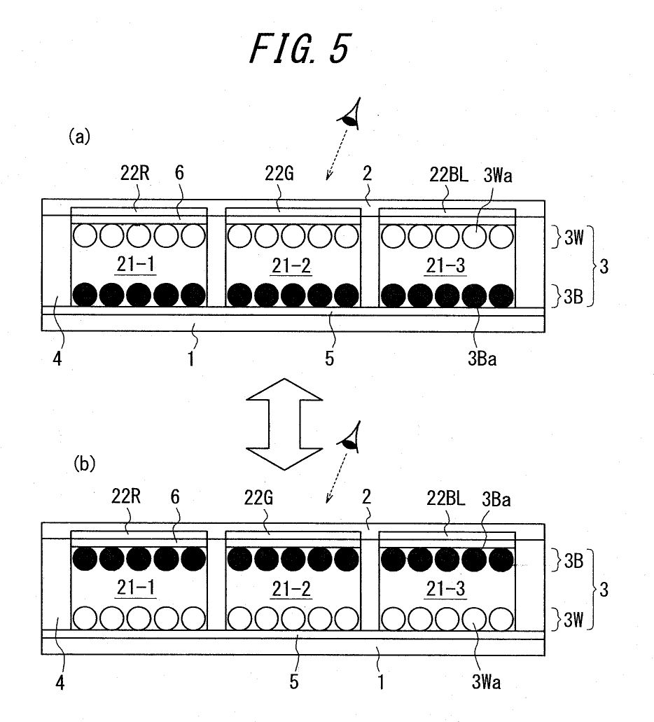

In the examples shown in FIGS. 5a and 5b, a color display utilizing a unit pixel constituted by three cells is explained. In the examples shown in FIGS. 5a and 5b: the white color display media 3W and the black color display media 3B are filled in all cells 21-1 to 21-3 as the display media; a red color filter 22R is arranged to the first cell 21-1 at the observer's side; a green filter 22G is arranged to the second cell 21-2 at the observer's side; and a blue color filter 22BL is arranged to the third cell 21-3 at the observer's side, so that the unit pixel is constructed by the first cell 21-1, the second cell 21-2 and the third cell 21-3. In this embodiment, as shown in FIG. 5a, a white color display is performed for the observer by arranging the white color display media 3W to all the first cell 21-1 to the third cell 21-3 at the observer's side, or, as shown in FIG. 5b, a black color display is performed for the observer by arranging the black color display media 3B to all the first cell 21-1 to the third cell 21-3 at the observer's side. Moreover, in FIGS. 5a and 5b, the partition walls arranged at the near side are omitted.

The above explanations can be applied to a case such that the white color display media 3W made of the particles are substituted by white color display media made of the liquid powders or a case such that the black color display media 3B made of the particles are substituted by black color display media made of the liquid powders.

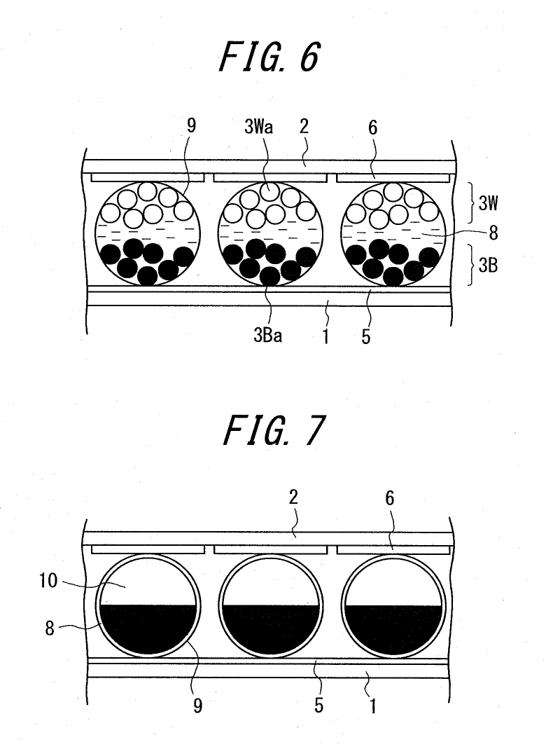

In the examples shown in FIG. 6 and FIG. 7, another embodiment, wherein the white/black color display is performed by utilizing the line electrodes 5 and 6 as is the same as the embodiment shown in FIGS. 2a and 2b, is explained. In the example shown in FIG. 6, use is made of a micro capsule 9, in which the white color display media 3W and the black color display media 3B are filled together with an insulation liquid 8, in stead of the cell formed by the partition walls 4, in which the white color display media 3W and the black color display media 3B are filled as shown in FIGS. 2a and 2b. Moreover, in the example shown in FIG. 7, use is made of a micro capsule 9, in which a rotating ball 10 whose surface is divided into halves, one half being a white color and the other half being a black color, is filled together with an insulation liquid 8, in stead of the cell formed by the partition walls 4, in which the white color display media 3W and the black color display media 3B are filled as shown in FIGS. 2a and 2b. In both examples shown in FIG. 6 and FIG. 7, the white/black color display can be performed, as is the same as the embodiment shown in FIG. 2b.

The features of the method of driving the information display panel according to the invention are as follows. That is, in the method of driving the information display panel, in which an electrostatic field is applied more than once for moving the display media in respective pixels, during a time interval at which an electrostatic field is not applied in the course of said multiple electrostatic field application, an electrostatic field application for the other multiple electrostatic field application is performed. Hereinafter, one specific embodiment of the information display panel according to the invention will be explained.

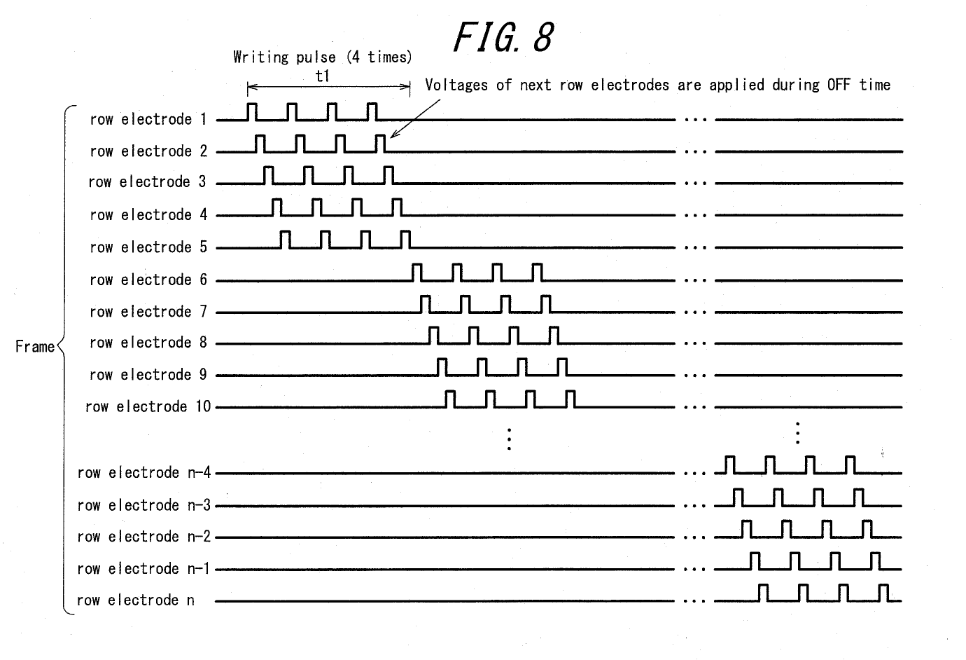

FIG. 8 is a schematic view explaining one embodiment of a method of driving an information display panel according to the invention. In the embodiment shown in FIG. 8, as the information display panel which is an object for driving, use is made of the information display panel, wherein, in a passive matrix drive, in which a voltage is applied to a plurality of row electrodes extending in a row direction on one substrate and a plurality of column electrodes extending in a column direction on the other substrate by scanning the row electrode from one end to the other end, a plurality of pulse voltages each constructed by a drive voltage having ON state and a voltage having OFF state below a threshold value at which the display media starts to move.

In the embodiment shown in FIG. 8, during the OFF state of the first pulse voltage of the row electrode 1 which becomes firstly a display standard for displaying, a pulse voltage showing ON state is applied successively as the first pulse voltage with respect to a plurality of row electrodes (here, row electrode 2-row electrode 5) other than the row electrode 1 which is the display standard. In this manner, an electrostatic field application is performed with respect to the pixels relating to the row electrode 2-row electrode 5. In this embodiment, since at least four pulse voltages showing ON state are included during the OFF state of the row electrode 1 which is the display standard, it is possible to apply the first pulse voltage showing ON state to the row electrode 2-row electrode 5 during the OFF state of the row electrode 1. Then, if four pulse voltages are successively applied in the manner mentioned above, it is possible to finish the pulse voltage applications of the first writing pulse with respect to the row electrode 1-row electrode 5 within a time interval t1 required for applying the pulse voltage of the writing pulse with respect to the row electrode 1. In this case, it is necessary not to change pulse width and pulse applying times.

Then, the row electrode 6 becomes the display standard for displaying. Also in this case, as is the same as the embodiment mentioned above, it is possible to finish the pulse voltage applications of the first writing pulse with respect to the row electrode 6-row electrode 10 within a time interval t1 required for applying the pulse voltage of the writing pulse with respect to the row electrode 6. Then, if the operations mentioned above are repeated successively, with respect to the row electrode n−4 which is the last display standard for displaying, it is possible to finish the pulse voltage applications of the first writing pulse with respect to the row electrode n−4-row electrode n within a time interval t1 required for applying the pulse voltage of the writing pulse with respect to the row electrode n−4. If the operation mentioned above is finished, it is possible to display an image of 1 frame.

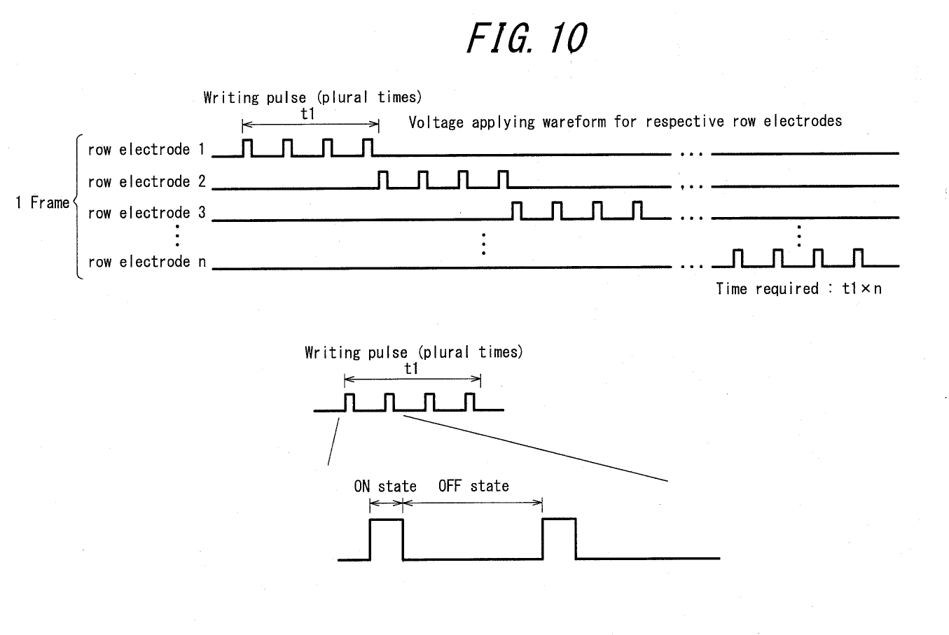

For example, in the known embodiment shown in FIG. 10, it takes a time interval of t1×n for displaying 1 frame. On the other hand, in the embodiment according to the invention shown in FIG. 8, it takes a time interval of t1×n÷5 for displaying 1 frame. Therefore, if the known embodiment shown in FIG. 10 is compared with the embodiment according to the present invention shown in FIG. 8, it is possible to shorten a time required for displaying 1 frame (corresponding to a time interval for displaying 1 image) by one-fifth. In this case, the embodiment shown in FIG. 8 is one example, in which four row electrodes are simultaneously driven within the time interval t1 of the writing pulse for one row electrode. However, the number of simultaneous voltage applying row electrodes is varied corresponding to a relation between ON state and OFF state. Therefore, an effect for shortening the image display is varied correspondingly.

Hereinafter, respective members constituting the information display panel according to the invention will be explained in detail.

As the substrate, at least one of the substrates is the transparent substrate 12 through which a color of the display media can be observed from outside of the information display panel, and it is preferred to use a material having a high transmission factor of visible light and an excellent heat resistance. The other substrate 11 may be transparent or may be opaque. Examples of the substrate material include polymer sheets such as polyethylene terephthalate, polyethylene naphthalate, polyether sulfone, polyethylene, polycarbonate, polyimide or acryl and metal sheets having flexibility and inorganic sheets such as glass, quartz or so having no flexibility. The thickness of the substrate is preferably 2 to 5000 μm, more preferably 5 to 2000 μm. When the thickness is too thin, it becomes difficult to maintain strength and distance uniformity between the substrates, and when the thickness is thicker than 5000 μm, there is a drawback as a thin-type information display panel. In the case such that the display device 1 is stacked under the position detector 2, it is necessary to use a transparent device such as a resistor film type touch panel, an ultrasonic type touch panel, a dot sensor type touch panel and so on as the position detector 2.

As a material of the electrode arranged according to need in the case of arranging the electrode to the information display panel, use is made of metals such as aluminum, silver, nickel, copper, gold, or, conductive metal oxides such as indium tin oxide (ITO), zinc-toped indium tin oxide (IZO), aluminum-doped zinc oxide (AZO), indium oxide, conductive tin oxide, antimony tin oxide (ATO), conductive zinc oxide and so on, or, conductive polymers such as polyaniline, polypyrrole, polythiophene and so on, and they are used by being suitably selected. As an electrode forming method, use is made of a method in which the materials mentioned above are made to a thin film by means of sputtering method, vacuum vapor deposition method, CVD (chemical vapor deposition) method, coating method and so on, a method in which a metal foil (for example, rolled copper foil) is laminated, or, a method in which conductive materials and solvents are mixed with synthetic resin binder and the mixture is sprayed. A transparency is necessary for the electrode arranged to the substrate 2 at an observation side (display surface side), but it is not necessary to the substrate 1 at a rear side. In both cases, the materials mentioned above, which are transparent and have a pattern formation capability, can be suitably used. Additionally, the thickness of the electrode may be suitable unless the electro-conductivity is absent or any hindrance exists in optical transparency, and it is preferable to be 0.01 to 10 μm, more preferable to be 0.05 to 5 μm. The material and the thickness of the electrode arranged to the rear substrate 1 are the same as those of the electrode arranged to the substrate at the display side, but transparency is not necessary. In this case, the applied outer voltage may be superimposed with a direct current or an alternate current.

As the partition wall 4 arranged according to need to the substrate, a shape of the partition wall is suitably designed in accordance with a kind of the display media used for the display and is not restricted. However, it is preferred to set a width of the partition wall to 2-100 μm more preferably 3-50 μm and to set a height of the partition wall to 10-100 μm more preferably 10-50 μm.

Moreover, as a method of forming the partition wall, use may be made of a double rib method wherein ribs are formed on the opposed substrates respectively and they are connected with each other and a single rib method wherein a rib is formed on one of the opposed substrates only. The present invention may be preferably applied to both methods mentioned above.

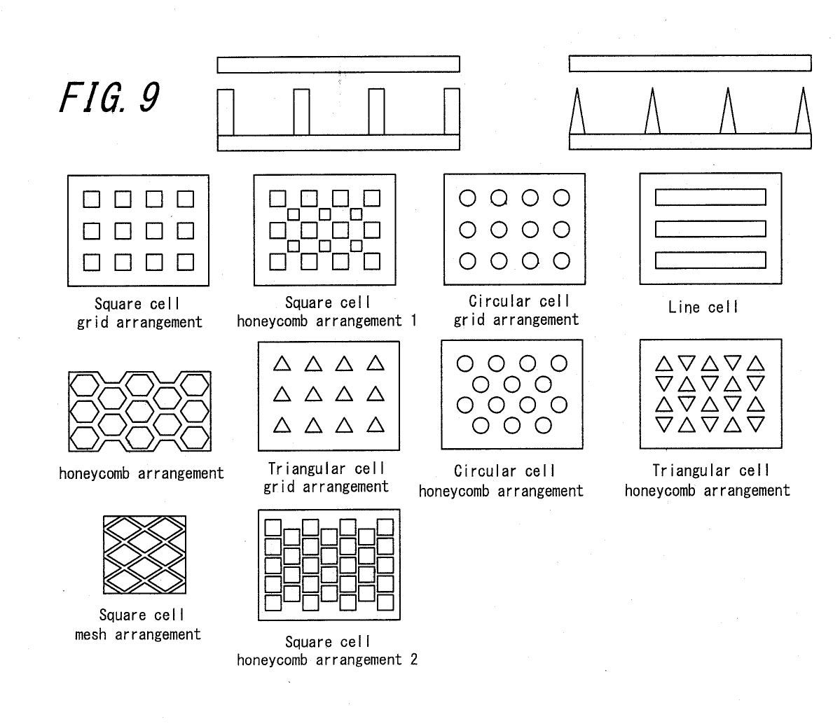

The cell formed by the partition walls each made of rib has a square shape, a triangular shape, a line shape, a circular shape and a hexagon shape, and has an arrangement such as a grid, a honeycomb and a mesh, as shown in FIG. 9 viewed from a plane surface of the substrate. It is preferred that the portion corresponding to a cross section of the partition wall observed from the display side (an area of the frame portion of the display cell) should be made as small as possible. In this case, a clearness of the image display can be improved.

The formation method of the partition wall is not particularly restricted, however, a die transfer method, a screen-printing method, a sandblast method, a photolithography method and an additive method. Among them, it is preferred to use a photolithography method using a resist film or a die transfer method.

Then, liquid powders used as for example display media in the information display panel according to the invention will be explained. It should be noted that a right of the name of liquid powders used in the information display panel according to the invention is granted to the applicant as “liquid powders” (Registerd): register No. 4636931.

In the present invention, a term “liquid powders” means an intermediate material having both of liquid properties and particle properties and exhibiting a self-fluidity without utilizing gas force and liquid force. Preferably, it is a material having an excellent fluidity such that there is no repose angle defining a fluidity of powder. For example, a liquid crystal is defined as an intermediate phase between a liquid and a solid, and has a fluidity showing a liquid characteristic and an anisotropy (optical property) showing a solid characteristic (Heibonsha Ltd.: encyclopedia). On the other hand, a definition of the particle is a material having a finite mass if it is vanishingly small and receives an attraction of gravity (Maruzen Co., Ltd.: physics subject-book). Here, even in the particles, there are special states such as gas-solid fluidized body and liquid-solid fluidized body. If a gas is flown from a bottom plate to the particles, an upper force is acted with respect to the particles in response to a gas speed. In this case, the gas-solid fluidized body means a state that is easily fluidized when the upper force is balanced with the gravity. In the same manner, the liquid-solid fluidized body means a state that is fluidized by a liquid. (Heibonsha Ltd.: encyclopedia) In the present invention, it is found that the intermediate material having both of fluid properties and solid properties and exhibiting a self-fluidity without utilizing gas force and liquid force can be produced specifically, and this is defined as the liquid powders.

That is, as is the same as the definition of the liquid crystal (intermediate phase between a liquid and a solid), the liquid powders according to the invention are a material showing the intermediate state having both of liquid properties and particle properties, which is extremely difficult to receive an influence of the gravity showing the particle properties mentioned above and indicates a high fluidity. Such a material can be obtained in an aerosol state i.e. in a dispersion system wherein a solid-like or a liquid-like material is floating in a relatively stable manner as a dispersant in a gas, and thus, in the information display device according to the invention, a solid material is used as a dispersant.

The information display panel which is a target of the present invention has a construction such that the liquid powders composed of a solid material stably floating as a dispersoid in a gas and exhibiting a high fluidity in an aerosol state are sealed between opposed two substrates, wherein one of two substrates is transparent. Such liquid powders can be made to move easily and stably by means of Coulomb's force and so on generated by applying a low voltage.

As mentioned above, the liquid powders mean an intermediate material having both of liquid properties and particle properties and exhibiting a self-fluidity without utilizing gas force and liquid force. Such liquid powders become particularly an aerosol state. In the information display device according to the invention, the liquid powders used in a state such that a solid material is relatively and stably floating as a dispersoid in a gas.

Then, the particles for the display media (hereinafter, called sometimes as particles) constituting the display media used in the information display panel according to the invention will be explained. The particles for the display media may be used as the display media constituted by the particles only, or, as the display media constituted by mixing various groups of the particles, or, as the display media constituted by the liquid powders obtained by controlling and mixing the particles.

The particle may be composed of resins as a main ingredient, and can include according to need charge control agents, coloring agent, inorganic additives and so on as is the same as the known one. Hereinafter, typical examples of resin, charge control agent, coloring agent, additives and so on will be explained.

Typical examples of the resin include urethane resin, urea resin, acrylic resin, polyester resin, acryl urethane resin, acryl urethane silicone resin, acryl urethane fluorocarbon polymers, acryl fluorocarbon polymers, silicone resin, acryl silicone resin, epoxy resin, polystyrene resin, styrene acrylic resin, polyolefin resin, butyral resin, vinylidene chloride resin, melamine resin, phenolic resin, fluorocarbon polymers, polycarbonate resin, polysulfon resin, polyether resin, and polyamide resin. Two kinds or more of these may be mixed and used. For the purpose of controlling the attaching force with the substrate, acryl urethane resin, acryl silicone resin, acryl fluorocarbon polymers, acryl urethane silicone resin, acryl urethane fluorocarbon polymers, fluorocarbon polymers, silicone resin are particularly preferable.

Examples of the electric charge control agent include, but not particularly specified to, negative charge control agent such as salicylic acid metal complex, metal containing azo dye, oil-soluble dye of metal-containing (containing a metal ion or a metal atom), the fourth grade ammonium salt-based compound, calixarene compound, boron-containing compound (benzyl acid boron complex), and nitroimidazole derivative. Examples of the positive charge control agent include nigrosine dye, triphenylmethane compound, the fourth grade ammonium salt compound, polyamine resin, imidazole derivatives, etc. Additionally, metal oxides such as ultra-fine particles of silica, ultra-fine particles of titanium oxide, ultra-fine particles of alumina, and so on; nitrogen-containing circular compound such as pyridine, and so on, and these derivates or salts; and resins containing various organic pigments, fluorine, chlorine, nitrogen, etc. can be employed as the electric charge control agent.

As for a coloring agent, various kinds of organic or inorganic pigments or dye as will be described below are employable.

Examples of black pigments include carbon black, copper oxide, manganese dioxide, aniline black, and activate carbon.

Examples of blue pigments include C.I. pigment blue 15:3, C.I. pigment blue 15, Berlin blue, cobalt blue, alkali blue lake, Victoria blue lake, phthalocyanine blue, metal-free phthalocyanine blue, partially chlorinated phthalocyanine blue, first sky blue, and Indanthrene blue BC.

Examples of red pigments include red oxide, cadmium red, diachylon, mercury sulfide, cadmium, permanent red 4R, lithol red, pyrazolone red, watching red, calcium salt, lake red D, brilliant carmine 6B, eosin lake, rhodamine lake B, alizarin lake, brilliant carmine 3B, and C.I. pigment red 2.

Examples of yellow pigments include chrome yellow, zinc chromate, cadmium yellow, yellow iron oxide, mineral first yellow, nickel titanium yellow, navel orange yellow, naphthol yellow S, hanzayellow G, hanzayellow 10G, benzidine yellow G, benzidine yellow GR, quinoline yellow lake, permanent yellow NCG, tartrazinelake, and C.I. pigment yellow 12.

Examples of green pigments include chrome green, chromium oxide, pigment green B, C.I. pigment green 7, Malachite green lake, and final yellow green G.

Examples of orange pigments include red chrome yellow, molybdenum orange, permanent orange GTR, pyrazolone orange, Balkan orange, Indanthrene brilliant orange RK, benzidine orange G, Indanthrene brilliant orange GK, and C.I. pigment orange 31.

Examples of purple pigments include manganese purple, first violet B, and methyl violet lake.

Examples of white pigments include zinc white, titanium oxide, antimony white, and zinc sulphide.

Examples of extenders include baryta powder, barium carbonate, clay, silica, white carbon, talc, and alumina white. Furthermore, there are Nigrosine, Methylene Blue, rose bengal, quinoline yellow, and ultramarine blue as various dyes such as basic dye, acidic dye, dispersion dye, direct dye, etc.

Examples of inorganic additives include titanium oxide, zinc white, zinc sulphide, antimony oxide, calcium carbonate, pearl white, talc, silica, calcium silicate, alumina white, cadmium yellow, cadmium red, titanium yellow, Pressian blue, Armenian blue, cobalt blue, cobalt green, cobalt violet, ion oxide, carbon black, manganese ferrite black, cobalt ferrite black, copper powder, aluminum powder.

These coloring agents and inorganic additives may be used alone or in combination of two or more kinds thereof. Particularly, carbon black is preferable as the black coloring agent, and titanium oxide is preferable as the white coloring agent.

The particles for display media having a desired color can be produced by mixing the coloring agents mentioned above.

Moreover, as the average particle diameter d(0.5) of the particles for the display media (hereinafter, called sometimes as particles), it is preferred to set d(0.5) to 1-20 μm and to use even particles. If the average particle diameter d(0.5) exceeds this range, the image clearness sometimes deteriorated, and, if the average particle diameter is smaller than this range, an agglutination force between the particles becomes larger and the movement of the particles is prevented.

Further, it is preferred that particle diameter distribution Span of the particles, which is defined by the following formula, is less than 5 preferably less than 3:

Span=(d(0.9)−d(0.1))/d(0.5)

(here, d(0.5) means a value of the particle diameter expressed by μm wherein an amount of the particles having the particle diameter larger than or smaller than this value is 50%, d(0.1) means a value of the particle diameter expressed by μm wherein an amount of the particles having the particle diameter smaller than this value is 10%, and d(0.9) means a value of the particle diameter expressed by μm wherein an amount of the particles having the particle diameter smaller than this value is 90%).

If the particle diameter distribution Span of the particles is set to not more than 5, the particle diameter becomes even and it is possible to perform an even particle movement.

Furthermore, among the particles for display media, it is preferred to set a ratio of d(0.5) of the particles having smallest diameter with respect to d(0.5) of the particles having largest diameter to not more than 10. The particles having different charge characteristics with each other are moved reversely, even if the particle diameter distribution Span is made smaller. Therefore, it is preferred that the particle sizes of the particles are made to be even with each other, and same amounts of the particles are easily moved in a reverse direction, and thus that is this range.

Here, the particle diameter distribution and the particle diameter mentioned above can be measured by means of a laser diffraction/scattering method. When a laser light is incident upon the particles to be measured, a light intensity distribution pattern due to a diffraction/scattering light occurs spatially. This light intensity distribution pattern corresponds to the particle diameter, and thus it is possible to measure the particle diameter and the particle diameter distribution.

In the present invention, it is defined that the particle diameter and the particle diameter distribution are obtained by a volume standard distribution. Specifically, the particle diameter and the particle diameter distribution can be measured by means of a measuring apparatus Mastersizer 2000 (Malvern Instruments Ltd.) wherein the particles setting in a nitrogen gas flow are calculated by an installed analysis software (which is based on a volume standard distribution due to Mie's theory).

A charge amount of the display media properly depends upon the measuring condition. However, it is understood that the charge amount of the display media used for the display media in the information display panel substantially depends upon an initial charge amount, a contact with respect to the partition wall, a contact with respect to the substrate, a charge decay due to an elapsed time, and specifically a saturation value of the particles for the display media during a charge behavior is a main factor.

After various investigations of the inventors, it is fond that an adequate range of the charged values of the particles for the display media can be estimated by performing a blow-off method utilizing the same carrier particles so as to measure the charge amount of the particles for the display media.

Further, in the case that the display media such as the particles or the liquid powders are applied to a dry-type information display panel, it is important to control a gas in a gap surrounding the display media between the substrates, and a suitable gas control contributes an improvement of display stability. Specifically, it is important to control a humidity of the gap gas to not more than 60% RH at 25° C., preferably not more than 50% RH.

The above gap means a gas portion surrounding the display media obtained by substituting the electrodes 5, 6 (in the case that the electrodes are arranged inside of the substrate), an occupied portion of the display media 3, an occupied portion of the partition walls 4 and a seal portion of the device from the space between the substrate 1 and the substrate 2 for example in FIGS. 1a and 1b-FIGS. 3a and 3b.

A kind of the gap gas is not limited if it has the humidity mentioned above, but it is preferred to use dry air, dry nitrogen gas, dry argon gas, dry helium gas, dry carbon dioxide gas, dry methane gas and so on. It is necessary to seal this gas in the device so as to maintain the humidity mentioned above. For example, it is important to perform the operations of filling the particles or the liquid powders and assembling the substrate under an atmosphere having a predetermined humidity and to apply a seal member and a seal method for preventing a humidity inclusion from outside of the device.

In the information display panel which is an object of the driving method according to the invention, an interval between the substrates is not restricted if the particles or the liquid powders can be moved and a contrast can be maintained, and it is adjusted normally to 10-500 μm, preferably 10-200 μm. In the case of using the particles and the liquid powders including charged particles, it is adjusted to 10-100 μm, preferably 10-50 μm.

Moreover, it is preferred to control a volume occupied rate of the particles or the liquid powders in a space between the opposed substrates to 5-70 vol %, more preferably 5-60 vol %. If the volume occupied rate of the particles or the liquid powders exceeds 70 vol %, the particles or the liquid powders become difficult to move, and if it is less than 5 vol %, a sufficient contrast cannot be obtained and a clear image display is not performed.

### INDUSTRIAL APPLICABILITY

The image display panel according to the invention is applicable to the image display unit for mobile equipment such as notebook personal computers, electronic datebook, portable information equipment called as PDA (Personal Digital Assistants), cellular phones, handy terminal and so on; to the electric paper for electric book, electric newspaper and so on; to the bulletin boards such as signboards, posters, blackboards (whiteboards) and so on; to the image display unit for electric desk calculator, home electric application products, auto supplies and so on; to the card display unit for point card, IC card and so on; and to the display unit for electric advertisement, information board, electric POP (Point of Presence, Point of Purchase advertising), electric price tag, electric bin tag, electric musical score, RF-ID device and so on. In addition, it is also preferably applied to the image display unit for various electronic equipments such as POS terminal, car navigation systems, clock and so on. As another use, it is preferably applied to rewritable paper (information is rewrote by means of outer electric field generating means).

Moreover, the information display panel which is an object of the driving method according to the invention is applicable to the various types of the information display panels such as: simple matrix driving-type display panel and static driving-type display panel, both having no switching element; and outer electric field driving-type display panel utilizing an outer electric field.

1. A method of driving an information display panel: in which at least one group of display media constituted by at least one group of particles, at least one substrate being transparent; in which the display media, to which an electrostatic field generated between the substrates is applied, are made to move so as to display information such as an image; and in which an electrostatic field is applied more than once for moving the display media in respective pixels; characterized in that, during a time interval at which an electrostatic field is not applied in the course of said multiple electrostatic field application, an electrostatic field application for the other multiple electrostatic field application is performed.

2. The method of driving an information display panel according to claim 1, wherein, in a passive matrix drive, in which a voltage is applied to a plurality of row electrodes extending in a row direction on one substrate and a plurality of column electrodes extending in a column direction on the other substrate by scanning the row electrode from one end to the other end, when a plurality of pulse voltages each constructed by a drive voltage having ON state and a voltage having OFF state below a threshold value at which the display media starts to move, said other multiple electrostatic field application is performed by successively applying a pulse voltage having ON state to a plurality of row electrodes other than a row electrode which is a display standard, during which said row electrode which is the display standard is in OFF state.
